(19) United States
(12) Patent Application Publication
(10) Pub. No.: US 2007/0238334 A1
(43) Pub. Date: Oct. 11, 2007

(54) Sheath Terminal for Driving Cables

(76) Inventors: Jaume Prat Terradas, Barcelona (ES); Jordi Jornet Vidal, Barcelona (ES); Juan Manuel Dona Contero, Barcelona (ES)

Correspondence Address: BERENBAUM, WEINSHIENK & EASON, P.C, 370 17TH STREET, SUITE 4800, DENVER, CO, 80202, US

(21) Appl. No.: 11/673,492

(22) Filed: Feb. 9, 2007

(30) Foreign Application Priority Data
Feb. 2, 2006 (ES) P 200600338

(51) Int. Cl. H01R 13/44

(52) U.S. Cl. 439/141

(57) ABSTRACT

A sheath terminal including a tubular body adapted to be connected to the sheath of a driving cable, a plastic connecting member linked to the tubular body, and a sheath member steerably received within the connecting member. The connecting member has an insertion portion inserted inside the tubular body. The tubular body and the connecting member each have a respective radial projection which are joined together by at least one cushioning member arranged between an outer housing, the tubular body, and the connecting member. The tubular body is made by deep drawing that is economically advantageous, and does not require machining operations on the tubular body, or overmolding operations of the connecting member.

### CROSS REFERENCE TO RELATED APPLICATIONS

The present invention claims the benefit of and priority from the prior-filed Spanish Patent Application, No. P 200600338; filed Feb. 10, 2006; the subject matter of which hereby being specifically incorporated herein by reference for all that it discloses and teaches.

### BACKGROUND

The present device relates to a sheath terminal for driving cables, for example in gearbox or brake devices in motor vehicles. In such applications, the driving cable has a structural configuration adapted to provide a certain degree of rigidity and to be able to transmit tensile and compression stresses. This cable runs inside a sheath which is retained in position in a support member fixed to the vehicle through a terminal.

The terminal typically includes a tubular body axially attached around the sheath of the driving cable and a connecting member linked to said tubular body and intended for steeringly receiving a sheath member.

Sheath terminals in driving cables generally are composed of a metal tubular body externally riveted around the sheath, which may be provided with steel wires therein. In some applications a housing for receiving the terminal may be provided, inside of which cushioning members may be provided for reducing vibrations produced during operation of the assembly.

In known, conventional sheath terminals, the end of a sheath member may be steeringly received within said tubular body, for example, by means of a ball joint. The steering ability of the sheath member allows the cable to be guided by the sheath in different directions with respect to the terminal so that it is adapted to the geometry of the location where the sheath is positioned in the vehicle during operation. In this case, the end of the tubular body may be correspondingly provided with a spherical housing for receiving the ball joint end of the steerable sheath member. The ends of the housing may become slightly deformed to obtain a neck joining both pieces.

The main disadvantages with these conventional sheath terminals are associated with the tubular body that is riveted around the outside of the sheath. This piece may be conventionally made from a steel bar which inner diameter may be machined along a substantial portion of its length in order to define a geometry that defines respective resistant surfaces. This machining operation negatively affects the final cost of the piece, further resulting in a significant waste of material.

The tubular body of the terminal may conventionally be alternatively made by molding of zinc alloys. However, use of zinc alloys may result in a piece having lower mechanical properties with respect to a tubular body made of steel.

A sheath terminal is described in the European Patent EP0627570 comprising a tubular steel body that is connected, through a connecting member, to a plastic sheath member the end of which is spherical in shape for establishing a ball joint. In this case, it is also required that the tubular steel body be machined for arranging a connecting member therein, by means of an over-injection process, for connecting the sheath member.

Although this terminal of EP0627570 involves improvements with respect to terminals previously described, it still involves a piece that is expensive to manufacture. Because this tubular body is a steel piece, machining operations may involve significant cost. In addition, the over-molding step involves an increase in the time of process, as a deviation in the assembly line is typically used for arranging the parts of the terminal in the injection station.

### BRIEF DESCRIPTION

A sheath terminal for driving cables is herein described which may be obtained more economically with respect to conventional sheath terminals since machining operations in the tubular body, and overmolding operations of the connecting member are no longer necessary.

Particularly, the sheath terminal hereof includes a tubular body that is fixed around the sheath, for example, by riveting. This tubular body may be made by a deep drawing process that may be advantageous since both outer and inner machining operations are removed, and consequently manufacturing costs may be considerably reduced.

The terminal hereof also includes a connecting member which steeringly receives a sheath member, the connecting member including an insertion portion that is inserted inside the tubular body, as if it was a plug. In this way, in one assembled position, a compact assembly formed by the tubular body and the connecting member may be obtained.

The connecting member may include a housing, for example a spherical housing, for receiving one end (for example, a spherical end) of the sheath member. This housing of the connecting member may be formed inside the connecting member, so that an expensive, over-injecting process is not necessary. The end of the sheath member may be mounted with a slight interference for providing an average strength joint.

According to one implementation hereof, the connecting member may be made from a plastic material and the inserting portion of said connecting member may have an outer diameter slightly greater than the inner diameter of the tubular body. The connecting member may be press fitted, through its inserting portion, inside the tubular body.

The tubular body or the connecting member, or preferably both, may have a radial projection. In the case that both the tubular body and the connecting member have respective radial projections, the radial projections may be disposed adjacent each other in the assembly position of the terminal.

In one implementation, the sheath terminal may have a housing inside of which at least one cushioning member may be received. This cushioning member may reduce vibrations that are propagated, for example, from the motor to the gearbox and from there to the gearshift.

The cushioning member may be arranged between the housing and the connecting member, or between the housing and the tubular body, typically in the portion where the radial projection is formed. However, in one preferred embodiment, the cushioning member may be provided between the housing and the connecting member and the tubular body, at both sides of the radial projections of the connecting member and the tubular body, respectively. In the assembled position, the cushioning member may be disposed to hold the connecting member and the tubular body operably adjacent and/or connected together by and through their respective projections.

The connecting member may have an inner diameter that is slightly greater than the outer diameter of the cable. This may facilitate the driving cable being passed through the inside of the connecting member. In addition, if the connecting member is made of plastic, apart from having certain degree of elasticity, its inner surface may provide a suitable guidance for the inner metal cable to slide therewithin, resulting in a much more effective assembly. Therefore an inner plastic sleeve may no longer be required to provide such a guiding feature, as was typically required with sheath terminals described in the prior art.

With the above described configuration, a resulting sheath terminal for driving cables may be simpler and less expensive, with the additional advantage that it may facilitate mounting of the assembly.

Other objects, advantages and features of the sheath terminal for driving cables of the invention will be clear from the description of the device. This description is given as a non-limiting example and it is illustrated in the drawings herein enclosed.

### BRIEF DESCRIPTION OF THE DRAWINGS

In the drawings:

FIG. 1 is an elevational, sectional view of one implementation of a sheath terminal for driving cables, particularly including the tubular body with the connecting member inserted therein;

FIG. 2 is an enlarged, fragmentary, elevational and sectional view of the sheath terminal in FIG. 1, in which, among other components, the tubular body, the connecting member and sheath member are shown in one assembled position; and,

FIG. 3 is an elevational, sectional view of the terminal in FIG. 1 in which one portion of the length of the sheath and the cable arranged therein is shown.

### DETAILED DESCRIPTION

In the Figures, see particularly FIGS. 2 and 3, a sheath terminal, generally indicated at (1) A may be disposed to retain the sheath (2) of a driving cable (3) (see FIG. 3) in operable position. The sheath terminal (1) may fix the sheath (2) of the cable (3) to a support member (see FIG. 3) of the vehicle for allowing the cable (3) to be driven.

As shown most particularly in FIG. 3, but also in FIG. 2, the sheath terminal (1) may include a tubular body (4), a connecting member (5) and a sheath member (6).

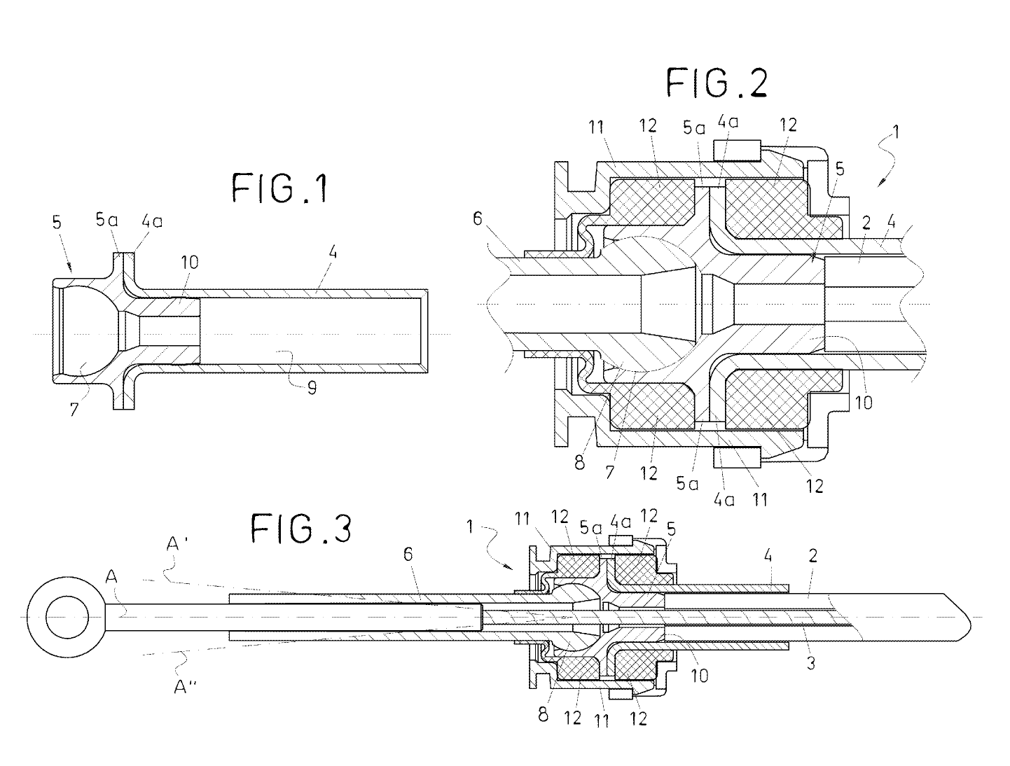

The tubular body (4) may take the form of a cylindrical steel hollow bar obtained by deep drawing (see e.g., FIG. 1). The tubular body (4) may be fixed around the sheath (2) by riveting, or by any other suitable axial retaining means.

The connecting member (5) may be a substantially cylindrical body made of a plastic material (see e.g., FIG. 1). The connecting member (5) may have, at one end thereof, an inserting portion (10) adapted to be inserted in the interior (9) of the tubular body (4), as it can be seen in the attached figures, particularly in FIG. 1.

The connecting member (5) may steeringly receive and operably retain the sheath member (6) (see e.g., FIGS. 2 and 3). For this purpose, the connecting member (5) may include a housing (7) (FIGS. 1 and 2), formed inside this opposed end, which may have an open spherical geometry for receiving and operably retaining a spherical end (8) of the sheath member (6), as shown in FIGS. 2 and 3, defining a ball joint. This configuration may allow mobility of the sheath member (6) in different directions, as for example the ones indicated at (A, A′, A″) in FIG. 3.

The inserting portion (10) of the connecting member (5) may have an outer diameter slightly greater than the inner diameter of the tubular body (4), so that the connecting member (5) is press fitted, by and through its inserting portion (10), into the interior (9) of the tubular body (4). Such a press fit may hold connecting member (5) connected to tubular body (4).

Both the tubular body (4) and the connecting member (5) each may further have a respective radial projection (4a, 5a). In the assembled position of the terminal (1) as is shown in the figures, both radial projections (4a, 5a) are arranged adjacent each other.

As shown in FIG. 3, the driving cable (3) may run inside the tubular body (4), the connecting member (5) and the sheath member (6). The connecting member (5) may have an inner diameter slightly greater than the outer diameter of the cable (3) for facilitating the passage of the cable therethrough. In addition, if connecting member (5) is made of plastic, this may provide an appropriate guiding feature for the metallic inner cable (3) to slide back and forth therewithin.

As shown in FIGS. 2 and 3, the sheath terminal (1) may have an outer housing (11) inside of which cushioning members (12) are received for a purpose of reducing vibrations in operation. The cushioning members (12) may be individual, discrete members or they may be formed by a single piece. The cushioning members (12) may be arranged or disposed in position between the housing (11) and the connecting member (5) and the tubular body (4).

As shown in FIGS. 2 and 3, the cushioning members (12) may be mounted on both longitudinal sides of the radial projections (4a, 5a) of the connecting member (5) and the tubular body (4), respectively, contacting the opposed outer faces thereof, holding them operably disposed adjacent or joined together during operation. If the cushioning member (12) is made up of a single piece, it should include an inner radial groove for receiving the total radial projection defined by the adjacent projections (4a, 5a).

While the present invention has been described in the specification and has been depicted in the enclosed drawings with reference to one preferred embodiment, the sheath terminal of the invention may have numerous embodiments without departing from the scope of protection defined in the following claims.

What is claimed is:

1. A sheath terminal for driving cables, the driving cable including a sheath, the sheath terminal comprising a sheath member, a tubular body and a connecting member; the tubular body being axially fixed around the sheath of the driving cable and the connecting member being linked to said tubular body and adapted to steeringly receive the sheath member, wherein the connecting member comprises an inserting portion suitable to be inserted in the interior of said tubular body.

2. Sheath terminal as claimed in claim 1, wherein said connecting member is made of a plastic material, and said inserting portion of said connecting member has an outer diameter slightly greater than the inner diameter of the tubular body, so that the connecting member is press fitted, through its inserting portion, in the interior of the tubular body.

3. Sheath terminal as claimed in claim 1, wherein said tubular body has a radial projection.

4. Sheath terminal as claimed in claim 1, wherein said connecting member has a radial projection.

5. Sheath terminal as claimed in claim 1, wherein the tubular body and the connecting member both have respective mutually adjacent radial projections.

6. Sheath terminal as claimed in claim 5, further comprising a housing inside of which at least one cushioning member is disposed.

7. Sheath terminal as claimed in claim 6, wherein the cushioning member is positioned between the housing and said connecting member, in the portion where said radial projection is disposed.

8. Sheath terminal as claimed in claim 6, wherein the cushioning member is positioned between the housing and the tubular body, in the portion where said radial projection is disposed.

9. Sheath terminal as claimed in claim 1, wherein said connecting member has an inner diameter slightly greater than the outer diameter of the driving cable passing therethrough.

10. Sheath terminal as claimed in claim 1, wherein said tubular body is made by deep drawing.
